(19) United States
(12) Patent Application Publication
(10) Pub. No.: US 2006/0043729 A1
(43) Pub. Date: Mar. 2, 2006

(54) Security sheet bearing watermark with improved identifiability

(76) Inventors: Volkmar Schwitzky, Wurzburg (DE); Vincent Morean, Lausanne (CH); Boris Loischer, Lausanne (CH)

Correspondence Address: RICHARD I. SAMUEL;GOODWIN PROCTER L.L.P, 599 LEXINGTON AVE., NEW YORK, NY, 10022, US

(21) Appl. No.: 11/150,760

(22) Filed: Jun. 10, 2005

Related U.S. Application Data
(63) Continuation-in-part of application No. 10/055,822, filed on Jan. 23, 2002, now abandoned.
Application No. 10/055,822 is a continuation of application No. PCT/DE00/02330, filed on Jul. 15, 2000.

(30) Foreign Application Priority Data
Jul. 28, 1999 (DE) 199 35 170.8

(51) Int. Cl. B42D 15/00

(52) U.S. Cl. 283/72

(57) ABSTRACT

A printed security sheet bearing a distinguishing feature such as a watermark with improved identifiability. The printed security sheet comprises a distinguishing feature covered with two layers of lacquer, and the rest of the surface of the printed security sheet covered with one layer of lacquer, whereby the lacquer on the distinguishing feature is thicker than the lacquer on the rest of the surface of the printed security sheet. The invention also provides a method for prepared the printed security.

### CROSS-REFERENCE TO RELATED APPLICATIONS

This is a continuation-in-part application of application Ser. No. 10/055,822, filed on Jan. 23, 2002, which is a continuation of International Patent Application No. PCT/DE00/02330 designating the United States, filed on Jul. 15, 2000, published on Feb. 8, 2001 as WO 01/08899, which claims priority of DE 199 35 170.8, filed on Jul. 28, 1999. The related applications are all incorporated herein by reference in their entirety.

### FIELD OF THE INVENTION

The invention relates to a process for finishing printed security sheets.

### BACKGROUND OF THE INVENTION

Watermarks produced during the production of “security papers” are a well-known security feature of security papers.

A watermark can be produced by generating a selectively different construction on the body of the paper with respect to the thickness and/or the density of the material by appropriate processes during the manufacture of the paper.

The desired motifs (such as portraits) can be produced in the paper by the different construction, for example, by variable light transparency of the material generated in the paper. In this connection, it is a disadvantage that the motif becomes clearly visible only when the paper is placed on a light table or held against light. Moreover, these papers are worn away heavily during use so that, as a result, it is no longer possible in some cases to identify the security feature.

### SUMMARY OF THE INVENTION

It is an object of the present invention to provide a process for finishing printed security sheets, so that the security features can be identified better.

It is also an object of the present invention to provide a finished printed security sheets comprising a distinguishing feature such as a watermark with improved identifiability.

In accordance with an aspect of the present invention, there is provided a method for increasing the identifiability of a distinguishing feature, for example a watermark, on a printed security sheet and increasing the durability of the security sheet, comprising the steps of: partially coating the printed security sheet with a layer of lacquer to the distinguishing feature, whereby the distinguishing feature is emphasized by increasing the transparency thereof; and lacquering the printed security sheet over its whole surface to increase the durability of the security sheet.

In accordance with another aspect of the present invention, there is provided a printed security sheet prepared by the method of the present invention. The printed security sheet comprises a distinguishing feature covered with two layers of lacquer, and the rest of the surface of the printed security sheet covered with one layer of lacquer, whereby the lacquer on the distinguishing feature is thicker than the lacquer on the rest of the surface of the printed security sheet so that the identifiability of the distinguishing feature is increased.

In accordance with a further aspect of the present invention, there is provided a printed security sheet comprising a watermark covered with two layers of lacquer, and the rest of the surface of the printed security sheet covered with one layer of lacquer, whereby the lacquer on the watermark is thicker than the lacquer on the rest of the surface of the printed security sheet so that the identifiability of the watermark is increased.

### BRIEF DESCRIPTION OF THE DRAWINGS

FIG. 1 is a top plan view of a printed security sheet bearing a watermark.

FIG. 2 is a cross-sectional view of the printed security sheet taken along line A of FIG. 1.

### DETAILED DESCRIPTION OF THE INVENTION

The invention relates to a method for finishing printed security paper sheets to improve the recognition of security features such as watermarks. The printed security paper sheets may be partly or entirely covered with a lacquer used for increasing the durability of printed security paper sheets and for enhancing the security features.

The method of the present invention for increasing the identifiability of a distinguishing feature, specifically a watermark, on a printed security sheet comprises the steps of: partially coating the printed security sheet with a layer of lacquer to the distinguishing feature, whereby the distinguishing feature is emphasized by increasing the transparency thereof; and lacquering the printed security sheet over its whole surface to increase the durability of the security sheet.

The method of the present invention results in a security sheet, which comprises a distinguishing feature covered with two layers of lacquer, and the rest of the surface of the printed security sheet covered with one layer of lacquer, whereby the lacquer on the distinguishing feature is thicker than the lacquer on the rest of the surface of the printed security sheet. The security sheet may comprise more than distinguishing feature covered with two layers of lacquer.

By lacquering a printed security paper, especially with a colorless lacquer, the transparency of the paper is increased greatly, depending on the construction of the paper, the type of lacquer, the method of applying the lacquer and the amount applied. If a watermark of a security paper is lacquered on one or both sides, the motif of the watermark is visible more clearly, because of the different transparency, which results from the different construction of the paper. The watermark can be recognized clearly even without help (such as a source of light). This effect is intensified, for example, by sources of light or simply by a dark base.

The present invention can be better understood from the following description of preferred embodiment, taken in conjunction with the accompanying drawings. It should be apparent to those skilled in the art that the described embodiments of the present invention provided herein are merely exemplary and illustrative and not limiting. All features disclosed in the description may be replaced by alternative features serving the same or similar purpose, unless expressly stated otherwise. Therefore, numerous other embodiments of the modifications thereof are contemplated as falling within the scope of the present invention and equivalents thereto.

In an exemplary embodiment, a security sheet with a security feature such as a watermark, is printed in a printing press. Subsequently, after the printing process, the printed security sheet is lacquered in the printing press with a special lacquering device or in an external lacquering facility with a feeding apparatus and a sheet delivery apparatus.

Advisably, the whole sheet is lacquered and a certain part or parts of the whole sheet, for example, the part of the sheet with the watermark, is lacquered. Partial lacquering improves the identifiability of the security feature and lacquering the whole sheet prolongs the identifiability of the security feature and the service life of the security sheet, when used for a prolonged time.

Since the manufacturing process of the security sheets may be prolonged by the lacquering process, it is advantageous to carry out the lacquering process, that is, the total and partial lacquering, in one step. For this purpose, a first lacquering unit comprising a lacquering cylinder and a screen roller with a doctor blade is assigned to a printing cylinder and a second lacquering unit comprising a lacquering cylinder and a screen roller with a doctor blade is disposed upstream from the lacquering cylinder.

The lacquering may be carried out with any appropriate lacquer, for example a colorless lacquer.

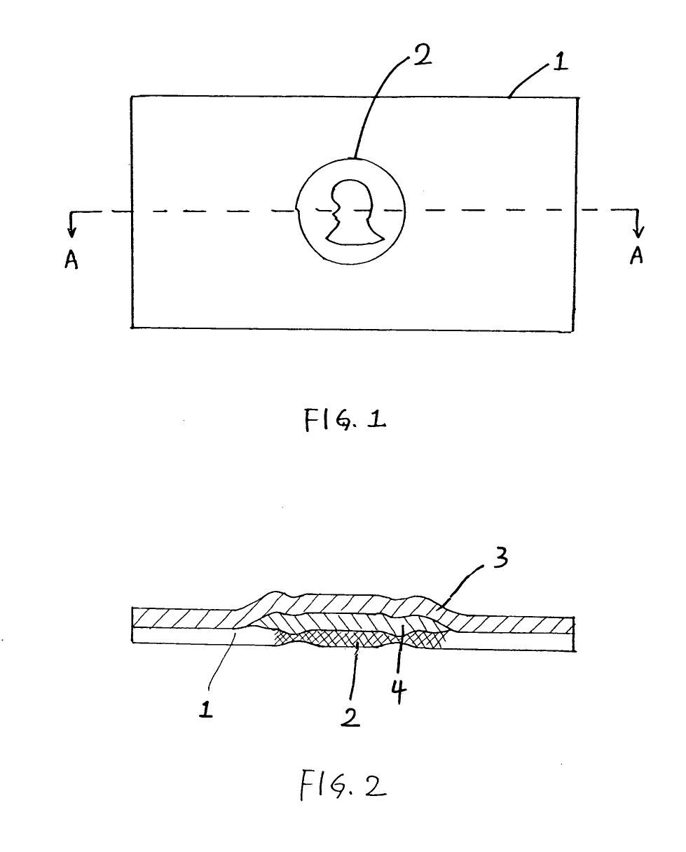

FIG. 1 illustrates a security sheet 1 bearing a watermark 2.

As shown in FIG. 2, the two step method of the present invention results in the security sheet 1 which comprises a watermark 2 covered with two layers of lacquer 3, 4, and the rest of the surface of the printed security sheet covered with one layer of lacquer 3, whereby the lacquer on the distinguishing feature is thicker than the lacquer on the rest of the surface of the printed security sheet.

While an exemplary embodiment and features of the present invention have been illustrated and described, it would be obvious to those skilled in the art that various other changes and modifications can be made without departing from the spirit and scope of the present invention. As will also be apparent to those skilled in the art, various combinations of the embodiments and features taught in the foregoing description are possible and can result in preferred executions of the present invention. Accordingly, it is intended that such changes and modifications fall within the scope of the present invention as defined by the claims appended hereto.

What is claimed is:

1. A security sheet bearing a watermark with increased identifiability, said printed security sheet comprising a watermark covered with two layers of lacquer, and the rest of the surface of said printed security sheet covered with one layer of lacquer, whereby the lacquer on the watermark is thicker than the lacquer on the rest of the surface of the printed security sheet so that the identifiability of said watermark is increased.

2. The security sheet of claim 1, comprising more than one watermark covered with two layers of lacquer.

3. The security sheet of claim 1, where said lacquer is a colorless lacquer.

4. The security sheet of claim 1, where said security sheet is a printed security sheet.
